(19) United States
(12) Patent Application Publication
(10) Pub. No.: US 2026/0285592 A1
(43) Pub. Date: Sep. 24, 2026

(54) STORAGE DEVICE COMPRISING AN INTEGRATED WORK AREA IN FRONT OF THE ACCESS AREA

(71) Applicant: Kardex Produktion Deutschland GmbH, Neuburg/Kammel (DE)

(72) Inventors: Norbert Bouché, Pleisweiler (DE); Nico Donner, Krumbach (DE)

(21) Appl. No.: 19/477,215

(22) PCT Filed: Jul. 10, 2024
(86) PCT No.: PCT/EP2024/069536

§ 371 Date: Oct. 21, 2025

(30) Foreign Application Priority Data
Jul. 11, 2023 (DE) 10 2023 118 300.1

(51) Int. Cl. B65G 1/04

(52) U.S. Cl. CPC B65G 1/0435; B65G 1/0485

(57) ABSTRACT

The invention relates to a storage device (1) comprising: at least two shelf columns (4) that are located opposite each other with respect to a storage shaft (2); a plurality of storage goods carriers (20) on which storage goods (25) can be placed; and at least one access area (6) which is accessible from outside the storage device through an access opening (42) allowing for the placement of storage goods on a storage goods carrier located in the access area and/or for the removal of storage goods from a storage goods carrier located in the access area, wherein: each shelf column has storage compartments (18) arranged one above the other in each of which two storage goods carriers can be accommodated one behind the other, as seen from the storage shaft; the storage device has a conveyor device (10) for transporting at least one storage goods carrier through the storage shaft between one of the storage compartments and the access area; and the storage device has at least one work area (8) which is accessible from outside the storage device and extends below the storage compartments of a shelf column from a front side (40) of the storage device towards the storage shaft up to the access opening. A storage device according to the invention saves space and allows quick access to the storage goods. At the same time, operation of the storage device is ergonomic.

### REFERENCE TO PENDING PRIOR PATENT APPLICATIONS

This patent application is a 371 national stage entry of pending prior International (PCT) Patent Application No. PCT/EP2024/069536, filed 10 Jul. 2024 by Kardex Produktion Deutschland GmbH for STORAGE DEVICE COMPRISING AN INTEGRATED WORK AREA IN FRONT OF THE ACCESS AREA, which patent application, in turn, claims benefit of German Patent Application No. 10 2023 118 300.1, filed 11 Jul. 2023.

The two (2) above-identified patent applications are hereby incorporated by reference.

### FIELD OF THE INVENTION

The present invention relates to a storage device.

### BACKGROUND OF THE INVENTION

Storage devices are used to temporarily store stored goods in storage compartments and to provide the stored goods as needed for a person or a robot operating the storage device in an access area. The transport of the stored goods in the storage device is generally carried out by a conveyor device that travels between the storage compartment and the access area. Stored goods may be removed or deposited via the access area. The stored goods are usually present in the storage device on storage goods carriers, for example trays, pallets, or containers.

Numerous requirements are imposed on storage devices. Thus, storage devices must allow rapid access to the stored goods or the storage goods carriers, and at the same time must take up little space. For frequent storage and/or retrieval operations by human operators, the access area must be designed as ergonomically as possible. Regardless of whether the access to the stored goods takes place via robots or humans, the rest of the operating procedure in the operating space in which the access area of the storage goods carrier is situated should be disturbed as little as possible by the storage or retrieval, and conversely, the operating procedure should disturb the storage or retrieval as little as possible.

### SUMMARY OF THE INVENTION

The object of the invention is to provide a storage device that meets these requirements.

This object is achieved by a storage device comprising at least two rack columns that are oppositely situated with respect to a storage shaft, a plurality of storage goods carriers on which stored goods may be placed, and at least one access area that is accessible from outside the storage device through an access opening for placing stored goods on a storage goods carrier situated in the access area and/or for removing stored goods from a storage goods carrier situated in the access area, wherein each rack column has storage compartments situated one above the other, in each of which two storage goods carriers are accommodatable one behind the other, viewed from the storage shaft, the storage device includes a conveyor device for transporting at least one storage goods carrier through the storage shaft between one of the storage compartments and the access area, and the storage device has at least one work area that is accessible from outside the storage device and extends below the storage compartments of a rack column, from a front side of the storage device toward the storage shaft and up to the access opening.

Such a work area has the advantage that the storage and/or retrieval take(s) place in an area that is delimited by the operating space. If the storage device is situated, for example, in a warehouse in which persons and vehicles move, these movements are not hindered by the person operating the storage device at the access area or by the robot present at the access area, since the work area does not block the walkways or driveways in the warehouse. The risk of collisions and accidents is reduced.

Furthermore, due to the protected position of the work area, a person present at the access area is shielded from visual, acoustic, or other types of distractions in the warehouse. This contributes to improved workplace ergonomics and thus, increased efficiency and enhanced work safety.

Since the work area is open toward the outside of the storage device, from the work area it is still possible to easily interact with persons or conveying equipment situated next to the storage device. For example, the person operating the storage device can load stored goods that are removed from the storage device onto a conveyor belt, or onto an order picking cart that extends next to the work area or is positioned next to the work area. Incorporation of the storage device into a logistical infrastructure is improved in this way.

The double-deep storage using two storage goods carriers situated one behind the other in a storage compartment allows a correspondingly deep work area, so that there is sufficient space for both the access area and the work area.

The above-mentioned invention may be further refined by the following features, each by itself being advantageous and arbitrarily combinable with the other features.

In one embodiment the storage goods carriers may thus have standardized, in particular identical, dimensions. The storage goods carriers may be tray-shaped and/or designed so that stored goods may be placed on them. Exactly two storage goods carriers are preferably accommodatable one behind the other in a storage compartment. Multiple storage goods carriers may also be situated side by side in the storage compartments or the racks.

The work area, preferably together with the access area, may be situated within a rack column or within the framework of a rack column. In particular, the supports of the rack columns may extend through the occupied area, for example at its corners. In this embodiment the rack column or its framework may protectively surround the work area. In addition, this embodiment simplifies the attachment of cladding of the work area, for example. The work area may thus be laterally cladded with wall elements. These wall elements may be fastened to the rack column or to its framework.

The access opening of the access area may be an opening in a wall that delimits the work area. The access opening may have a closeable, in particular automatically closeable, design. The access area may have an opening that is closeable, in particular with respect to the access opening, and that is open toward the storage shaft. The opening may preferably be automatically closeable. The wall may be formed by a wall element that is mounted on the rack column or its framework.

The storage device may have at least one safety device which in an activated state protects certain spaces from unauthorized access in order to avoid injury to operators.

The access opening may thus be provided with a safety device such as a light curtain. The safety device may be designed, in the activated state, to output an alarm signal when an object protrudes through the access opening.

Regardless of whether or not the access opening is provided with a safety device, a safety device, in particular a light curtain, may also be installed at the access point to the work area. This safety device may be designed, in the activated state, to output an alarm signal when an object protrudes through the access.

In one embodiment the work area may have a base area that corresponds, at least approximately, to an integer multiple of the base area of a storage goods carrier. The base area of the work area may also correspond to the simple base area of a storage goods carrier and/or may have the same contour as a storage goods carrier. The base area of the work area may correspondingly be regarded as the base area of a storage goods carrier if the base area of the work area does not differ from the base area of the storage goods carrier by more than 20%.

In the vertical direction the base area of the work area may overlap the base area of the rack column above the access opening. In addition, in the vertical direction the base area of the work area may lie within the base area of the rack column above the access opening.

The depth of the work area may correspond to the depth of a storage goods carrier. The depth of the work area may be correspondingly regarded as the depth of a storage goods carrier if the depth of the work area does not differ from the depth of a storage goods carrier by more than 20%. In addition, the depth of the work area may be at least approximately 40 cm and/or approximately 110 cm at most. The depth of the work area is preferably between approximately 50 cm and approximately 90 cm.

The storage device may also have multiple work areas. The work areas may be situated in the same or different storage columns. In particular, two or more work areas situated in the same storage column may be positioned at different heights or levels. Thus, for example, a first work area may be situated on the ground level of the storage device, and a second work area may be situated on the second level of the storage device. In addition, two or more work areas may be positioned at respectively different sides of the storage device. Thus, for example, one work area may be present on a front side, and a further work area may be present on a rear side, of the storage device. The rear side may be situated opposite from the front side relative to the longitudinal axis of the storage shaft.

According to one advantageous exemplary embodiment, the work area may have a width that corresponds at least to the width of a storage goods carrier. This ensures that a person operating the storage device can easily reach any location on the storage goods carrier along its width, but in particular the outer locations on the storage goods carrier, from the work area. This improves the operability of the storage device. This embodiment also ensures that a storage goods carrier can be removed from the storage device via the work area.

The width of the work area may preferably correspond to an integer multiple of the width of a storage goods carrier, or to the width of a storage goods carrier. The width of the work area may be correspondingly regarded as the width of a storage goods carrier if the width of the work area does not differ from the width of a storage goods carrier by more than 20%.

The work area may have a smaller width than the rack column situated above it. The width extends in the horizontal direction and perpendicularly to the direction in which the rack columns are oppositely situated.

According to a further aspect, the sum of the depth of the work area and the access area may correspond to the depth of one of the rack columns. The sum of the depth of the work area and the access area may preferably correspond to the depth of the rack column situated above it. According to this embodiment a storage device saves space, since a person present in the work area stands within the cubic volume of the storage device due to the fact that the work area is not situated outside the storage device.

A, in particular exactly one, storage goods carrier may be placeable in the access area in the depth direction. However, multiple storage goods carriers may optionally be placeable next to one another in the width direction.

The storage goods carriers or the trays may have an ergonomically advantageous depth (in particular one-half the depth of a storage goods carrier or of a storage compartment of the standard design of the storage goods carriers described above), so that a person operating the storage device, when removing stored goods from these narrow storage goods carriers or when placing stored goods on the narrow storage goods carriers, does not have to bend forward as much. In particular, the leverage with which stored goods are removed from the storage goods carrier or placed on the storage goods carrier may be reduced, since the person's arm does not have to be stretched out as far. The combined capacity of two narrow storage goods carriers may correspond to the capacity of a standard storage goods carrier.

The work area is preferably designed to be walked on. The height, in particular the clearance height, of the work area may correspond at least to the body height of the 95th percentile of adults between 18 and 65 years of age living in Germany, in accordance with DIN 33402-2. For example, the height, in particular the clearance height, may be between approximately 195 cm and approximately 220 cm. Furthermore, the height, in particular the clearance height, of the work area may correspond at least to the minimum height for headroom in accordance with DIN 18065, and may thus be greater than 2.07 m.

The work area may have a ceiling as part of an enclosure of the work area, which shields the work area from the rack column above it. In addition, the access area may have a roof that shields the work area from the rack column above it. The rack column may in particular be the same rack column as that above the work area. Furthermore, a roof of the area occupied by persons may extend, at least in sections, above the roof of the access area.

According to a further advantageous exemplary embodiment, a ceiling of the work area may be situated higher than a roof of the access area. This ensures that the height of the work area for the operator present therein is high enough, while storage place in the storage column situated above the access area or the work area is not wasted due to the access area having a lower design. Such a storage device is therefore space-saving and thus particularly economical. The work area may be enclosed on three sides, preferably by an enclosure of the storage area. The enclosure or its walls, as described above, may be mounted on a rack column and/or its framework. The width of the work area relative to the access may correspond to the width of the access. In addition, the work area may lie within the cubic volume or in the construction volume of the storage device. The storage device may have a cuboidal cubic volume, for example.

The work area may be accessible through an opening, which preferably extends down to the floor, in the enclosure of the storage area. In one embodiment the opening of the work area is situated opposite from the access opening. The opening may extend over the entire width of the storage area.

According to a further aspect, the storage device may include at least one storage compartment that is designed as a buffer compartment. The buffer compartment is designed for temporarily storing storage goods carriers between their stored good compartment and the access area.

According to a further advantageous exemplary embodiment, the conveyor device may be designed to remove two storage goods carriers situated one behind the other from a storage compartment, and at the same time to move them to the at least one buffer compartment; of the two storage goods carriers situated one behind the other, to place the storage goods carrier situated on the side of the access area in the at least one buffer compartment; and to move the remaining storage goods carrier to the access area. If the conveyor device can transport only one storage goods carrier at a time, this embodiment of the storage device makes it possible for the rear storage goods carrier situated in the storage compartment to also be delivered in the access area.

The buffer compartment represents a storage compartment that is always available. The buffer compartment may be designated as dynamic or static. A static buffer compartment is always present at the same location. A dynamic buffer compartment is formed by a currently available storage place of a storage compartment that abuts the storage shaft.

In a rack column in which the access area is situated, the side of a storage compartment facing away from the access opening is the side of storage compartment facing away from the storage shaft. In a rack column that is situated opposite from the access area, the side of a storage compartment facing away from the access opening is the side facing away from the storage shaft.

The front side of a storage compartment is the side facing the storage shaft, and the rear side is the side facing away from the storage shaft; accordingly, the rear storage goods carrier in a storage compartment is the storage goods carrier on the side facing away from the storage shaft, and the front storage goods carrier is the storage goods carrier that is situated at the storage shaft. Thus, for a fully occupied storage compartment, the front storage goods carrier is situated between the storage shaft and the rear storage goods carrier.

The location at which a storage goods carrier is stored in a storage compartment is referred to as a storage place. For two storage goods carriers situated one behind the other in a storage compartment, a storage compartment thus has two storage places, a rear storage place and a front storage place.

If two storage goods carriers are situated one behind the other on the conveyor device, and the storage goods carrier facing away from the access opening is to be moved into the access area, it is advantageous for the storage goods carrier facing the side of the access opening to first be removed from the conveyor device and brought into a storage compartment that is used as a buffer compartment.

In one embodiment, the conveyor device may be designed to access the storage goods carrier on the front storage place and transport it to the buffer compartment and/or access area. Alternatively or additionally, the conveyor device may be designed to access only the particular storage goods carrier of a storage compartment that is situated in the front storage place, and transport it to the buffer compartment and/or access area.

Alternatively or additionally, the conveyor device may be designed to access the particular storage goods carrier that is situated in a rear storage place, and transport it to the buffer compartment and/or access area. This may require that the front storage place of the storage compartment is free.

Alternatively or additionally, the conveyor device may be designed to simultaneously access the two storage goods carriers of a storage compartment. In particular, the conveyor device may be provided to simultaneously move the two storage goods carriers of a storage compartment from the storage compartment and to the access area and/or to the buffer compartment, in particular to also move them back.

The conveyor device may be designed to simultaneously transport two or more storage goods carriers in two or more corresponding shelves situated one above the other. For this purpose, the conveyor device may have two or more shelves or storage places situated one above the other. In particular, at least one of the shelves may be used as a buffer compartment.

Furthermore, the conveyor device may be designed to move the storage goods carrier from the storage compartment and to the access area or to the buffer compartment, in particular to also move it back.

According to a further advantageous exemplary embodiment, the storage device may be designed to remove two storage goods carriers situated one behind the other from a storage compartment and simultaneously move them to the at least one buffer compartment; of the two storage goods carriers situated one behind the other, to place the storage goods carrier situated on the side of the access area in the at least one buffer compartment; and to move the remaining storage goods carrier to the access area.

In this way, of the of the two storage goods carriers situated one behind the other, only the storage goods carrier facing away from the access area is moved to the access area and made accessible.

According to a further aspect of the invention, the storage device may be designed to move a storage goods carrier from the access area to the buffer compartment; to receive a storage goods carrier that is placed in the buffer compartment; and to move the received storage goods carrier, together with the storage goods carrier that is moved from the access area to the buffer compartment, to a free storage compartment and place both storage goods carriers there.

Such an embodiment makes it possible for two storage goods carriers, which prior to placing the one storage goods carrier in the buffer compartment were situated pairwise next to one another in a storage compartment, to once again be received situated pairwise next to one another after the access to the other storage goods carrier in the access area and after the one storage goods carrier is received in the buffer compartment.

The storage device may preferably have a controller that controls the conveyor device, the transport of storage goods carriers via the conveyor device, and in particular the above functionalities.

According to a further advantageous exemplary embodiment, the buffer compartment may be situated above the access area and/or above the work area. Due to such an embodiment, the distance between the access area and the buffer compartment is reduced. If the storage goods carrier facing away from the access area and the storage goods carrier facing the access area are now accessed in succession, the path to be traveled by the conveyor device to the buffer compartment is short. The changeover times or the access times are thus reduced and the productivity is increased.

According to a further embodiment, the buffer compartment may be situated above, in particular directly above, or below, in particular directly below, the access area. The buffer compartment may be formed by the lowermost storage compartment of the rack column above the access area. This shortens the path to be traveled by the conveyor device and thus reduces the access times. According to one embodiment, there is no buffer compartment above the work area. In particular, the buffer compartment may be situated between the work area or a ceiling of the work area and the storage shaft, in the horizontal direction.

The ceiling of the work area may be situated at least at the height of the buffer compartment, and more storage compartments, including the buffer compartment, may be situated above the access area than above the work area.

Alternatively or additionally, the buffer compartment may be situated below the access area. More storage compartments, including the buffer compartment, may be situated below the access area than below the work area.

According to a further exemplary embodiment, two storage goods carriers situated one behind the other in a storage compartment may each have mutually complementary, mutually coupleable couplings which in the coupled-together state tightly connect the two storage goods carriers to one another. The conveyor device can thus access a rear storage goods carrier facing away from the storage shaft without directly moving it. Instead, the conveyor device may access the front storage goods carrier facing the storage shaft, as a result of which the movement of the storage goods carrier, via the coupling, is transferred to the rear storage goods carrier facing away from the storage shaft.

The tight connection is understood to mean, for example, that traction acting on the front storage goods carrier is transferred to the rear storage goods carrier connected thereto. The coupled-together couplings may also form a pressure-tight connection, so that a pressure on the front storage goods carrier may be transferred, via the coupled-together couplings, to the rear storage goods carrier. In such an embodiment, the rear storage goods carrier may be pushed into the rear storage place by pressure on the front storage goods carrier.

According to a further aspect, the couplings may have a coupleable or uncoupleable design due to a vertical relative movement of two storage goods carriers situated directly one behind the other. If two storage goods carriers situated one behind the other are in a coupled state, the two storage goods carriers together may be pushed into a storage compartment or removed therefrom. However, due to the fact that the two storage goods carriers are uncoupleable, it is also possible to remove only the storage goods carrier facing the storage shaft. Analogously, it is possible to place only the storage goods carrier facing the storage compartment in an empty storage compartment. Such a storage device can thus flexibly respond to how many storage goods carriers must be pushed into a buffer compartment or removed therefrom. The efficiency of the storage device is increased in this way.

The front storage goods carrier or the storage goods carrier facing the storage shaft may be moved into the storage shaft to couple and uncouple the couplings. In particular, the storage goods carrier may be moved into the storage shaft by means of the conveyor device.

The couplings may be uncoupled by moving the front storage goods carrier downwardly relative to the rear storage goods carrier, in particular when the front storage goods carrier is situated in the storage shaft. The front storage goods carrier may be situated on the conveyor device, and the rear storage goods carrier may be situated in the storage compartment.

The couplings may be coupled by moving the front storage goods carrier upwardly relative to the rear storage goods carrier, in particular when the front storage goods carrier is situated in the storage shaft. The front storage goods carrier may be situated on the conveyor device, and the rear storage goods carrier may be situated in the storage compartment.

According to a further advantageous exemplary embodiment, a robot may be situated in the work area. The robot may be situated at the framework of the storage device, at a rack column, or at the rack column below or in which the work area is present. A gantry robot or a robotic arm, for example, may be used as a robot.

According to a further embodiment, the work area may have a ceiling behind which, on the side of the rack column, is situated at least one fastening point that is mounted on the supporting structure of the storage device, and/or at least one plug that is connected to lines for power supply and/or for data exchange. Lifting means that assist a person operating the storage device when lifting loads, for example stored goods, may be affixed to such a fastening point. Alternatively or additionally, a robot may be affixed to such a fastening point and/or plug, and by means of the plug may be integrated into the controller of the storage device. This increases productivity and user-friendliness. By providing a plug, electronic devices such as a tool or communication hardware may be used in the work area, which are advantageous for the work at the storage device or the control of the storage device.

The ceiling of the work area may have a modular design and may have multiple panels, for example. The panels may have a detachable design, in particular without removing further elements of the storage device. At least one electrical plug which is preferably connected to lines for supplying power and/or controlling the storage device may be situated behind at least one panel. At least one fastening element that is mounted on the framework of the storage device may be situated behind at least one panel. The fastening element is preferably mounted on a portion of the supporting structure of the storage device. A robotic arm or a gantry robot may be mounted on the fastening element.

According to a further advantageous exemplary embodiment, at least one apparatus from the following group of apparatuses may be situated in the work area:
a clothes hook,
a sound source,
a fragrance dispenser,
a light source that is variable with regard to a light spectrum and/or lighting intensity,
at least one drawer,
a camera,
an air conditioning unit,
a device for wireless data transmission,
a replaceable floor covering on the floor of the work area,
a projector with a projection surface,
an operator panel.

The various apparatuses of such a storage device improve the ergonomics of the storage device and contribute to the well-being of the person operating the storage device, which improves the operational reliability, productivity, and user-friendliness in general. In addition, by means of the various embodiments the individual physical and psychological needs and preferences of the person operating the storage device may be addressed. In particular, the sound source, the light source, the camera, and the device for wireless data transmission may also improve the communication of the person operating the storage device with the surroundings, as well as the controllability of the storage device. The work area may be customized in this way.

An air conditioner, a fan, or a heater, for example, may be used as the air conditioning unit. The device for wireless data transmission may in particular encompass Wi-Fi and Bluetooth. For example, a rubber mat that assists with work by the person operating the storage device in a back-supporting manner may be used as a replaceable floor covering on the floor of the work area.

The light source, the sound source, the fragrance source, and the air conditioning unit may be controlled automatically by means of a data transmitter situated at a predetermined distance from the area occupied by persons. The data transmitter may be, for example, a transponder that is worn by the person, a telephone, or an optical code on the work clothing. Instead of the optical code or in addition to the optical code, a QR code or a barcode may be provided on the work clothing. In addition, facial, speech, and/or voice recognition or other methods for identifying persons, in particular persons that are operating the storage device, may be present. The data transmitter may also communicate via RFID and/or NFC technologies, for example

Furthermore, at least one apparatus may also be situated outside the storage device in an area adjoining the work area.

The invention is explained in greater detail below, based on exemplary embodiments with reference to the appended figures. According to the above embodiments, individual features that are present in the exemplary embodiments described below may be omitted if the technical effect associated with these features is not relevant. Conversely, a feature that is described above but not present in an exemplary embodiment discussed below may be added to the exemplary embodiment if the technical effect associated with this feature is relevant for a certain application.

The same reference numerals are used for elements that correspond to one another with regard to structure and/or function.

### BRIEF DESCRIPTION OF THE DRAWINGS

In the figures:

FIG. 1 shows a schematic illustration of the storage device according to one possible exemplary embodiment;

FIG. 2 shows a schematic illustration of two storage goods carriers in the uncoupled state according to one possible exemplary embodiment;

FIG. 3 shows a schematic illustration of two storage goods carriers in the coupled state according to one possible exemplary embodiment;

FIG. 4 shows a schematic detailed illustration of the work area according to one possible exemplary embodiment;

FIG. 5 shows a schematic detailed illustration of the work area with a robot according to one possible exemplary embodiment;

FIG. 6 shows a schematic illustration of the storage device at the start of the storage process according to one possible exemplary embodiment;

FIG. 7 shows a schematic illustration of the storage device in step 1 according to one possible exemplary embodiment;

FIG. 8 shows a schematic illustration of the storage device in step 2 according to one possible exemplary embodiment;

FIG. 9 shows a schematic illustration of the storage device in step 3 according to one possible exemplary embodiment;

FIG. 10 shows a schematic illustration of the storage device in step 4 according to one possible exemplary embodiment;

FIG. 11 shows a schematic illustration of the storage device in step 5 according to one possible exemplary embodiment;

FIG. 12 shows a schematic illustration of the storage device in step 6 according to one possible exemplary embodiment;

FIG. 13 shows a schematic illustration of the storage device in step 7 according to one possible exemplary embodiment;

FIG. 14 shows a schematic illustration of the storage device in step 8 according to one possible exemplary embodiment;

FIG. 15 shows a schematic illustration of the storage device in step 9 according to one possible exemplary embodiment;

FIG. 16 shows a schematic illustration of the storage device according to a further possible exemplary embodiment;

FIG. 17 shows a schematic illustration of the storage device with a smaller shelf surface according to one possible exemplary embodiment; and

FIG. 18 shows a schematic illustration of the storage device with a smaller shelf surface according to a further possible exemplary embodiment.

### DETAILED DESCRIPTION OF THE PREFERRED EMBODIMENTS

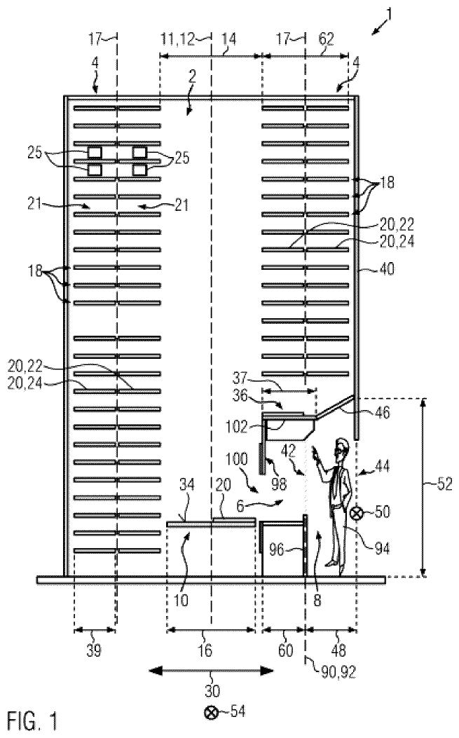

The design of a storage device 1 is first described, with reference to FIGS. 1 through 5 by way of example.

The storage device 1 comprises a storage shaft 2, rack columns 4, an access area 6, a work area 8, and a conveyor device 10. The storage shaft 2 with its longitudinal axis 11 extends along a longitudinal axis 12 of the storage device 1. The storage shaft 2 is designed in such a way that the conveyor device 10 may be moved therein along the longitudinal axis 11 of the storage shaft 2 or along the longitudinal axis 12 of the storage device 1. As a result, a width 14 of the storage shaft 2 is greater than a width 16 of the conveyor device 10.

The rack columns 4 are situated opposite from the storage shaft 2, so that longitudinal axes 17 of the rack columns 4 extend in parallel to the longitudinal axis 12 of the storage device 1 or in parallel to the longitudinal axis 11 of the storage shaft 2. Each rack column 4 has a plurality of storage compartments 18 situated one above the other along the longitudinal axis 17 of the rack column 4, in particular situated in parallel to one another.

Two storage goods carriers 20 situated one behind the other with respect to the storage shaft 2 are accommodatable in each storage compartment 18. Each storage compartment 18 thus has two storage places 21 situated one behind the other, on which a storage goods carrier 20 is placeable in each case.

A storage compartment 18 in which two storage goods carriers 20 are accommodated has a front storage goods carrier 22 facing the storage shaft 2 and a rear storage goods carrier 24 facing away from the storage shaft. The storage goods carriers 20 may have standardized, in particular identical, dimensions and may be tray-shaped, for example. Container-shaped storage goods carriers are also possible.

The storage goods carriers 20 are designed so that stored goods 25 may be placed on them. In the exemplary embodiment shown in FIG. 1, exactly two storage goods carriers 20 are situated one behind the other in a storage compartment 18. According to a further embodiment, however, a storage compartment 18 may accommodate fewer than or more than two storage goods carriers 20.

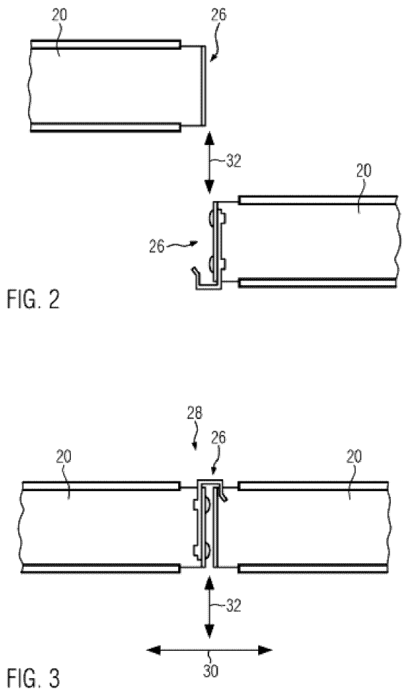

According to one possible exemplary embodiment shown in FIG. 2, two storage goods carriers 20 situated one behind the other in a storage compartment 18 may have mutually complementary couplings 26. In a coupled state 28 (see FIG. 3) the two storage goods carriers 20 are connected to one another in a tight and/or pressure-tight manner via the couplings 26. When one of the two storage goods carriers 20 is moved along a depth direction 30, this movement is transferred, via the couplings 26, to the other storage goods carrier 20.

Two storage goods carriers 20 in the coupled state 28 may be uncoupled by moving the two storage goods carriers 20 away from one another by a vertical relative movement 32. Analogously, two storage goods carriers 20 not in the coupled state 28 may be coupled, and thus transferred into the coupled state 28, by moving the two storage goods carriers 20 toward one another by a vertical relative movement 32. The vertical relative movement 32 may extend along the longitudinal axis 11 of the storage shaft 2, the longitudinal axis 17 of the rack columns 4, and the longitudinal axis 12 of the storage device 1. In particular, the vertical relative movement 32 may be initiated by a movement of the conveyor device 10.

The conveyor device 10 is movable through the storage device 1 along the longitudinal axis 11 of the storage shaft 2, and has a shelf surface 34 on which at least one storage goods carrier 20 may be placed. The conveyor device 10 is designed to move storage goods carriers 20 through the storage shaft 2. The conveyor device 10 transports at least one storage goods carrier 20 from a storage compartment 18 to the access area 6, or from the access area 6 to a storage compartment 18.

According to one exemplary embodiment, the conveyor device 10 may move at least one storage goods carrier 20, but preferably may simultaneously move two storage goods carriers 20 situated one behind the other, from a storage compartment 18 to a buffer compartment 36. The storage goods carriers 20 may be connected to one another via the couplings 26 or may be in the coupled state 28. In the exemplary embodiment described in FIG. 1, the buffer compartment 36 is situated above the access area 6 of the storage device 1. The buffer compartment 36 has a depth 37 that extends along the depth direction 30. The depth 37 of the buffer compartment 36 may correspond to a depth 39 of a storage goods carrier 20. The depth 39 of the storage goods carrier 20 likewise extends along the depth direction 30.

The work area 8 of the storage device 1 is situated at a rack column 4, below the storage compartments 18, and extends from a front side 40 of the storage device 1 in the direction of the storage shaft 2 up to an access opening 42 of the access area 6. The work area 8 is accessible from outside the storage device 1. The storage device 1 or the work area 8 may have an access 44 for this purpose. The access 44 may be situated at the front side 40 of the storage device 1.

The access 44 may be open so that the work area 8 is freely accessible, in particular for a person 94, from outside the storage device 1 via an access 44.

Alternatively, the access 44 may be secured by doors, a light curtain, etc. This is meaningful, for example, when a robot is operated in the work area 8 and entry into the work area is not permitted for safety reasons.

In the exemplary embodiment shown in FIG. 1, the work area 8 has a ceiling 46 that shields the work area 8 from the rack column 4 above it.

The work area 8 has a depth 48, a width 50, and a height 52. The height 52 of the work area 8 extends along the longitudinal axis 11 of the storage shaft 2, the longitudinal axis 12 of the storage device 1, and the longitudinal axis 17 of the rack columns 4. The depth 48 of the work area 8 extends along the depth direction 30, which extends perpendicularly to the longitudinal axis 11 of the storage shaft 2, perpendicularly to the longitudinal axis 17 of the rack columns 4, and perpendicularly to the longitudinal axis 12 of the storage device 1. The width 50 of the work area 8 extends along a width direction 54 that is oriented perpendicularly to the depth direction 30 and perpendicularly to the longitudinal axis 11 of the storage shaft 2, perpendicularly to the longitudinal axis 17 of the rack columns 4, and perpendicularly to the longitudinal axis 12 of the storage device 1. In FIG. 1 the width direction 54 extends perpendicularly to the level under consideration. According to one possible exemplary embodiment, the width 50 of the work area 8 may correspond at least to a width 56 (not shown) of the storage goods carrier 20.

The sum of the depth 48 of the work area 8 and a depth 60 of the access area 6 may correspond to a depth 62 of the rack columns 4. The depth 62 of the rack columns 4 extends along the depth direction 30.

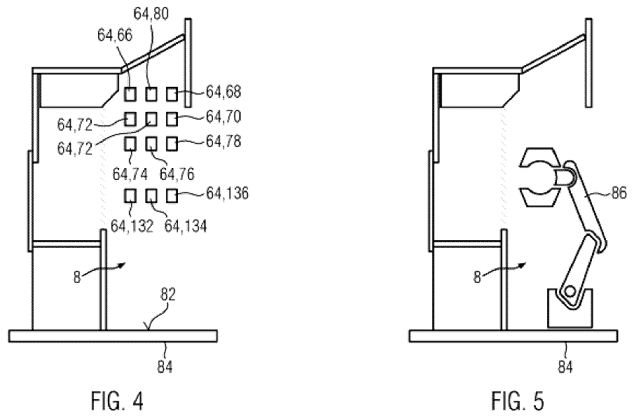

The work area 8 of the storage device may also have at least one apparatus 64. According to one embodiment shown in FIG. 4, the work area 8 includes a clothes hook 66, a sound source 68, a fragrance dispenser 70, two light sources 72, a drawer 74, a camera 76, an air conditioning unit 78, a device for wireless data transmission 80, a floor covering 82, a projector with a projection surface 132, a screen 134, and an operator panel 136. The floor covering 82 is situated on a floor 84 of the work area 8.

As shown in FIG. 5, a robot 86 may be situated in the work area 8. The robot 86 may be a gantry robot or a robotic arm, for example. The robot 86 may, for example, be fastened to a framework of the storage device 1, to a rack column 4, and/or to the rack column 4 situated below/in the work area 8. In addition, the robot 86 may also stand on the floor 84 of the work area 8.

The access area 6 is situated between the storage shaft 2 and the work area 8 in the depth direction 30. In particular, the access area 6 extends from an end 88 [sic; 98] of the storage shaft 2 facing away from the longitudinal axis 11 of the storage shaft 2 up to an end 90 of the work area 8 facing the storage shaft 2. The access area 6 has the access opening 42 at the end 90 of the work area 8 facing the storage shaft 2 or at an end 92 of the access area 6 facing away from the storage shaft 2. In the exemplary embodiment shown in FIG. 1, the access opening 42 is designed as an opening in a wall 96. The wall 96 delimits the work area 8 at its end 90 facing the storage shaft 2. The access opening 42 may be closeable, in particular automatically closeable. The access area 6 may have an in particular automatically closeable opening 100 at the end 98 of the access area 6 facing the storage shaft 2. The opening 100 may be situated opposite from the access opening 42 of the access area 6, so that the access opening 42 of the access area 6 is spaced apart from the opening 100 in the depth direction 30. Storage goods carriers 20 may be moved from the storage shaft 2 into the access area 6 by means of the conveyor device 10, for example, via the opening 100 of the access area 6. The access area 6 may also have a roof 102. In the exemplary embodiment illustrated in FIG. 1, the ceiling 46 of the work area 8 in part is situated higher than the roof 102 of the access area 6.

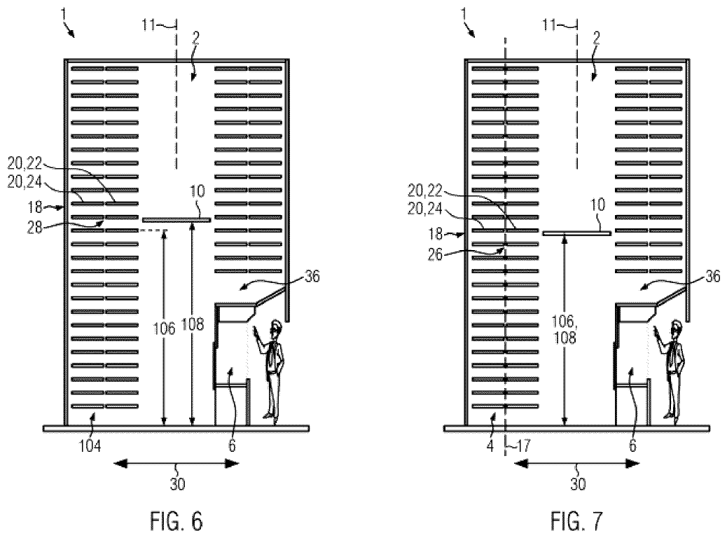

The operating principle of the storage device 1 according to one possible exemplary embodiment is described below with reference to FIGS. 6 through 15. The operating principle of the storage device is not limited to the sequence of steps described below, which is used solely for illustration.

It is first explained how, of two storage goods carriers 20 situated one behind the other in the same storage compartment 18, a storage goods carrier 24 facing away from the storage shaft 2 is transported along the depth direction 30 from the storage compartment 18 to the access area 6, and how a storage goods carrier 22 facing the storage shaft 2 is transported from the same storage compartment 18 to the buffer compartment 36. The storage compartment 18 is situated in a rack column 104 facing away from the access area 6.

At the start (see FIG. 6), both storage goods carriers 22, 24 are stored in the same storage compartment 18, which is situated in the rack column 104 opposite from the access area 6, and at a height 106. The storage goods carriers 22, 24 are situated one behind the other along the depth direction 30. The two storage goods carriers 22, 24 are in the coupled state 28, so that the storage goods carrier 24 facing away from the storage shaft 2 is connected to the storage goods carrier 22 facing the storage shaft 2 in a tight and pressure-tight manner. According to a further embodiment, the stored goods carriers 22, 24 may also be coupled together only tightly or only in a pressure-tight manner. The conveyor device 10 is situated at a height 108 in the storage shaft 2. The height 108 of the conveyor device 10 extends along the longitudinal axis 11 of the storage shaft 2.

In a first step, the conveyor device 10 is moved along the longitudinal axis 11 of the storage shaft 2, in the direction of the storage compartment 18 in which the goods carriers 20 to be transported are stored, until the height 108 of the conveyor device 10 corresponds to the height 106 of the storage compartment 18 (see FIG. 7). The conveyor device 10 is then next to the storage compartment 18 in relation to the depth direction 30.

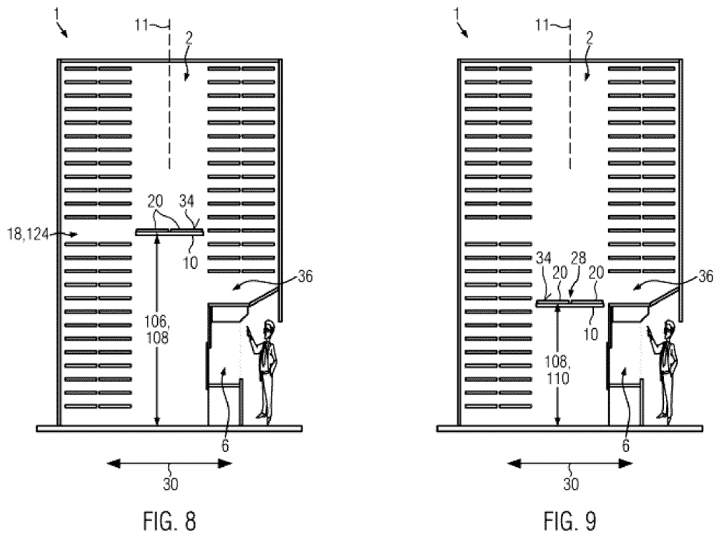

In a second step, the two storage goods carriers 20 are moved together onto the conveyor device 10, along the depth direction 30 and on the longitudinal axis 11 of the storage shaft 2, until the storage goods carriers 20 are completely situated on the shelf surface 34 of the conveyor device 10 (see FIG. 8). In the described exemplary embodiment, the storage goods carrier 20 facing away from the access area 6 is placed in the access area 6. For this purpose, the storage goods carrier 20 facing the access area 6 initially is temporarily stored in the buffer compartment 36 as described below. The two storage goods carriers 20 may be coupled together, for example as described above.

In a third step, the conveyor device 10 is moved along the longitudinal axis 11 of the storage shaft 2, in the direction of the buffer compartment 36, until the height 108 of the conveyor device 10 corresponds to the height 110 of the buffer compartment 36 (see FIG. 9).

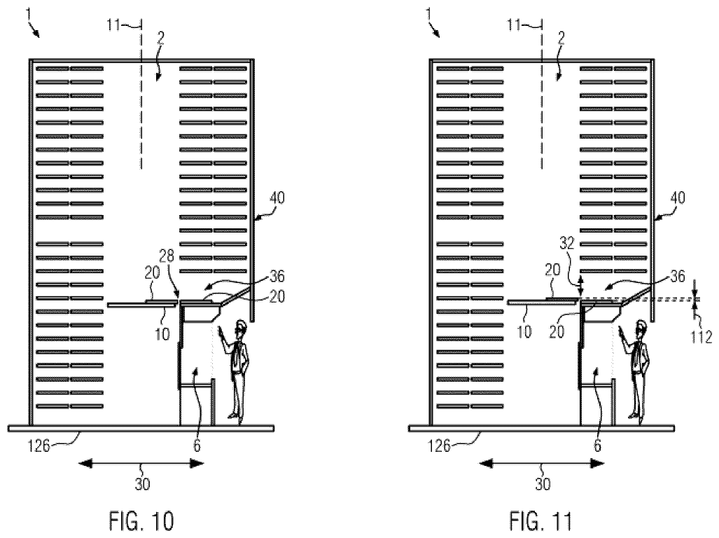

In a fourth step, the two storage goods carriers 20 are moved along the depth direction 30 and toward the front side 40 of the storage device 1 until the storage goods carrier 20 facing the access area 6 has been completely pushed into the buffer compartment 36 (see FIG. 10). The two storage goods carriers 20 are still in the coupled state 28.

In a fifth step, the coupled state 28 of the storage goods carriers 20 is discontinued by separating the couplings 26 from one another via the vertical relative movement 32. For this purpose, the conveyor device 10 together with the storage goods carrier 20 remaining on it is moved upwardly along the longitudinal axis 11 of the storage shaft 2, while the storage goods carrier 20 which is now situated in the buffer compartment 36 remains in the buffer compartment 36. The upward movement is directed perpendicularly away from the floor 126 of the storage device 1. After the coupled state 28 of the storage goods carriers 20 is discontinued, there is a vertical offset 112 (see FIG. 11) between the storage goods carrier 20 situated in the buffer compartment 36 and the storage goods carrier 20 remaining on the conveyor device 10. The fifth step may be omitted if no couplings or couplings designed in some other way, for example remote-control couplings, are present.

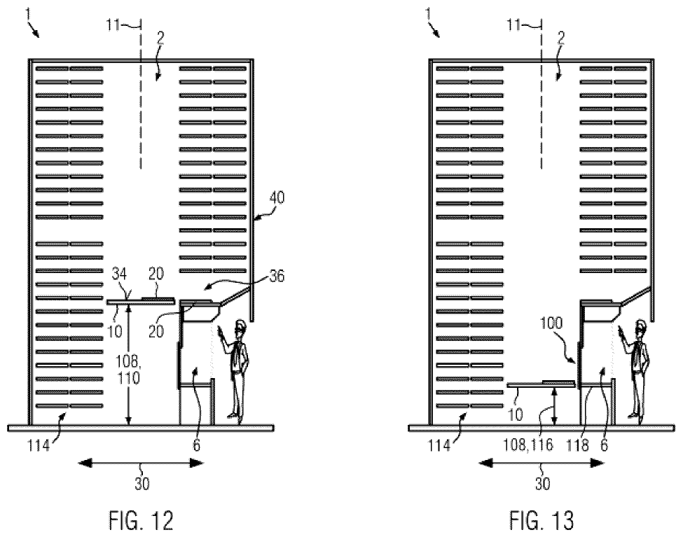

After the storage goods carriers 20 have been separated from one another, the storage goods carrier 20 remaining on the conveyor device 10 protrudes slightly from the conveyor device 10 in the direction of the access area 6, as is apparent in FIG. 11, when a coupling system as described above is used. Therefore, in a sixth step the storage goods carrier 20 remaining on the conveyor device 10 is moved along the depth direction 30 and in the direction of the rack column 114 facing away from the front side 40 of the storage device 1. The sixth step is concluded when the storage goods carrier 20 remaining on the conveyor device 10 is completely placed on the shelf surface 34 of the conveyor device 10 (see FIG. 12).

In a seventh step, the conveyor device 10 is moved along the longitudinal axis 11 of the storage shaft 2 in the direction of the access area 6 until the height 108 of the conveyor device 10 corresponds to a height 116 of a shelf 118 of the access area 6 (FIG. 13).

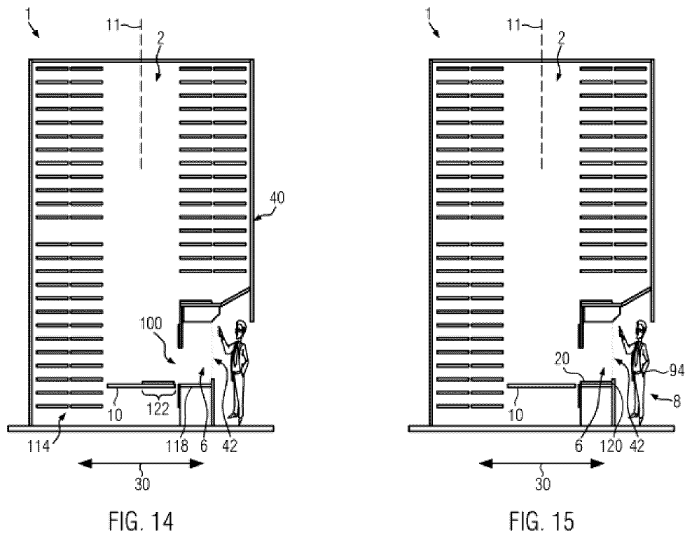

In an eighth step, the opening 100 of the access area 6 opposite from the access opening 42 is opened (FIG. 14), so that the storage goods carrier 20 situated on the conveyor device 10 may be pushed into the access area 6 or pushed onto the shelf 118 of the access area 6.

In a ninth step (see FIG. 15), for this purpose the storage goods carrier 20 situated on the conveyor device 10 is pushed, along the depth direction 30 and in the direction of the front side 40 of the storage device 1, into the access area 6 until an end 120 of the storage goods carrier 20 facing away from the storage shaft 2 abuts the access opening 42. After the ninth step concludes, a person 94 standing in the work area 8 or a robot 86 (not shown in FIG. 15) situated in the work area 8 can reach through the access opening 42 in order to place stored goods 25 (not shown) on the storage goods carrier 20 situated in the access area 6 and/or to pick up the stored goods from same. According to one possible embodiment, the access opening 42 may have been automatically opened or closed after the ninth step concludes, or before the stored goods 25 are deposited or picked up.

It is described below how the storage goods carrier 20 situated in the access area 6 and the storage goods carrier 20 situated in the buffer compartment 36 are transported back into a free storage compartment 124, for example the original storage compartment 18.

In a tenth step, the storage goods carrier 20 situated in the access area 6 is moved along the depth direction 30 and in the direction of the conveyor device 10 until the storage goods carrier 20 is completely situated on the shelf surface 34 of the conveyor device 10 (see FIG. 14). In particular, the storage goods carrier 20 may be situated on a side 122 of the conveyor device 10 facing the front side 40 of the storage device 1 after the tenth step concludes.

In step eleven, the opening 100 of the access area 6 opposite from the access opening 42 is closed (FIG. 13). The closing of the opening 100 preferably takes place automatically.

In the twelfth step, the conveyor device 10 is moved along the longitudinal axis 11 of the storage shaft 2 in the direction of the buffer compartment 36 until the height 108 of the conveyor device 10 corresponds to the height 110 of the buffer compartment 36 (FIG. 12).

To prepare for the coupling, in a thirteenth step the stored goods carrier 20 situated on the conveyor device 10 is moved along the depth direction 30 and in the direction of the front side 40 of the storage device 1, so that the storage goods carrier 20 protrudes from the conveyor device 10 in the direction of the front side 40 of the storage device 1 (see FIG. 11).

In an optional fourteenth step (see FIGS. 10 and 11), the coupled state 28 of the storage goods carriers 20 is re-established by coupling the couplings 26 via the vertical relative movement 32. For this purpose, the conveyor device 10 together with the storage goods carrier 20 situated on it is moved along the longitudinal axis 11 of the storage shaft 2 in the direction of the floor 126 of the storage device 1, while the storage goods carrier 20 situated in the buffer compartment 36 rests in the buffer compartment 36 without movement. After the vertical offset 112 between the storage goods carrier 20 situated on the conveyor device 10 and the storage goods carrier 20 situated in the buffer compartment 36 is eliminated, the storage goods carriers 20 are once again in the coupled state 28, as a result of which they are connected to one another in a tight and pressure-tight manner. According to a further exemplary embodiment, the storage goods carriers 20 may be connected to one another only tightly or only in a pressure-tight manner.

In the fifteenth step, the two storage goods carriers 20 situated one behind the other are moved together along the depth direction 30 and away from the front side 40 of the storage device 1 until the storage goods carriers 20 are completely situated on the shelf surface 34 of the conveyor device 10 (FIG. 9).

In a sixteenth step, the conveyor device 10 is subsequently moved along the longitudinal axis 11 of the storage shaft 2 until the height 108 of the conveyor device 10 corresponds to the height 106 of the storage compartment 18 in which one of the two storage goods carriers 20 or both storage goods carriers 20 is/are to be stored (FIG. 8). The storage compartment 18 is a free storage compartment 124.

In the seventeenth step, the storage goods carriers 20 are introduced into the free storage compartment 124 along the depth direction 30. In the exemplary embodiment shown in FIG. 7, the free storage compartment 124 is situated in the rack column 4 of the storage device 1 facing away from the access area 6. The coupled-together storage goods carriers 20 are completely accommodated in the storage compartment 18 or in the free storage compartment 124 when their couplings 26 are situated on the longitudinal axis 17 of the rack column 4 in which the storage compartment 18 is situated (see FIG. 7).

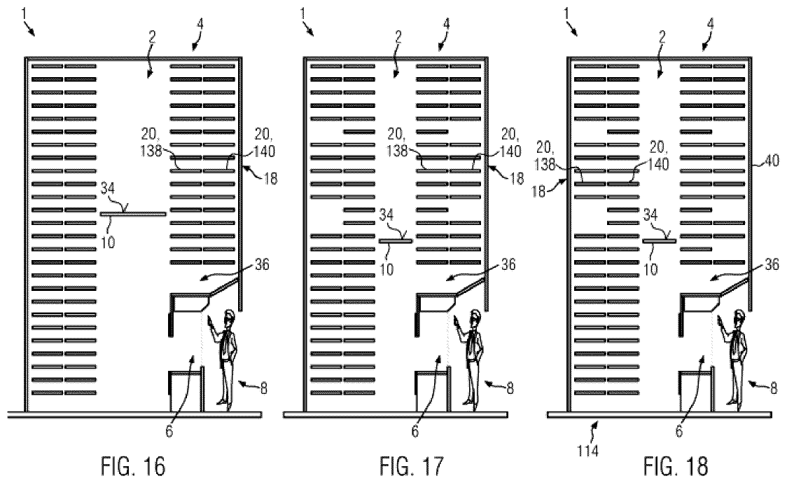

The operating principle of the storage device 1 is described below according to further possible exemplary embodiments, with reference to FIGS. 16 through 18.

In the exemplary embodiment illustrated in FIG. 16, the conveyor device 10 of the storage device 1 has the shelf surface 34 on which two storage goods carriers 20 situated one behind the other may be simultaneously transported. Initially a first storage goods carrier 138 and a second storage goods carrier 140 are situated one behind the other in the same storage compartment 18, which is situated in the rack column 4 in which the access area 6 or the work area 8 is situated. The first storage goods carrier 138 faces the storage shaft 2, and the second storage goods carrier 140 faces away from the storage shaft 2. If the first storage goods carrier 138 is now to be transported to the access area 6, initially both storage goods carriers 138, 140 are removed from the storage compartment 18 and moved onto the conveyor device 10. The conveyor device 10 is subsequently moved to the buffer compartment 36 and the second storage goods carrier 140 is placed in the buffer compartment 36, so that only the first storage goods carrier 138 remains on the conveyor device 10. The conveyor device 10 together with the first storage goods carrier 138 is subsequently moved to the access area 6, where the first storage goods carrier 138 may be provided or removed.

In the exemplary embodiment illustrated in FIG. 17, the conveyor device 10 of the storage device 1 has the shelf surface 34 on which only a single storage goods carrier 20 can be transported. The position of the two storage goods carriers 138, 140 at the start corresponds to the position of the two storage goods carriers 138, 140 in FIG. 16. If the second storage goods carrier 140 is now moved to the access area 6, initially the first storage goods carrier 138 is removed from the storage compartment 18 and moved onto the conveyor device 10. The conveyor device 10 is subsequently moved to the buffer compartment 36 and the first storage goods carrier 138 is placed in the buffer compartment 36. The conveyor device 10 is subsequently moved back to the storage compartment 18, where the second storage goods carrier 140 is picked up by the conveyor device 10. The conveyor device 10 subsequently moves to the access area 6, where the second storage goods carrier 140 may be provided or removed.

In FIG. 18, the first storage goods carrier 138 and the second storage goods carrier 140 are situated one behind the other in the same storage compartment 18, which is situated in the rack column 114 facing away from the front side 40 of the storage device 1. The first storage goods carrier 138 faces away from the storage shaft 2, and the second storage goods carrier 140 faces the storage shaft 2. The conveyor device 10, as shown in FIG. 17, can transport only a single storage goods carrier 20. If the first storage goods carrier 138 is now moved to the access area 6, initially the second storage goods carrier 140 is removed from the storage compartment 18 and moved onto the conveyor device 10. The conveyor device 10 is subsequently moved to the buffer compartment 36 and the second storage goods carrier 140 is placed in the buffer compartment 36. The conveyor device 10 is subsequently moved back to the storage compartment 18, where the first storage goods carrier 138 is picked up by the conveyor device 10. The conveyor device 10 is subsequently moved to the access area 6, where the first storage goods carrier 138 may be provided or removed.

### LIST OF REFERENCE NUMERALS

1 storage device
2 storage shaft
4 rack columns
6 access area
8 work area
10 conveyor device
11 longitudinal axis of the storage shaft
12 longitudinal axis of the storage device
14 width of the storage shaft
16 width of the conveyor device
17 longitudinal axes of the rack columns
18 storage compartment
20 storage goods carrier
21 storage place
22 storage goods carrier facing the storage shaft
24 storage goods carrier facing away from the storage shaft
25 stored goods
26 coupling
28 coupled state
30 depth direction
32 vertical relative movement
34 shelf surface of the conveyor device
36 buffer compartment
37 depth of the buffer compartment
39 depth of the storage goods carrier
40 front side of the storage device
42 access opening
44 access
46 ceiling of the work area
48 depth of the work area
50 width of the work area
52 height of the work area
54 width direction
56 width of the storage goods carrier
60 depth of the access area
62 depth of the rack columns
64 apparatus
66 clothes hook
68 sound source
70 fragrance dispenser
72 light source
74 drawer
76 camera
78 air conditioning unit
80 device for wireless data transmission
82 floor covering
84 floor of the work area
86 robot
88 end of the storage shaft facing away from the longitudinal axis of the storage shaft
90 end of the work area facing the storage shaft
92 end of the access area facing away from the storage shaft
94 person
96 wall
98 end of the access area facing the storage shaft
100 opening
102 roof of the access area
104 rack column facing away from the access area
106 height of the storage compartment
108 height of the conveyor device
110 height of the buffer compartment
112 vertical offset
114 rack column facing away from the front side of the storage device
116 height of the shelf of the access area
118 shelf of the access area
120 end of the storage goods carrier facing away from the storage shaft
122 side of the conveyor device facing the front side of the storage device
124 free storage compartment
126 floor of the storage device
128 fastening point
130 plug
132 projector with projection surface
134 screen
136 operator panel
138 first storage goods carrier
140 second storage goods carrier

1. A storage device (1),
comprising at least two rack columns (4) that are oppositely situated with respect to a storage shaft (2),
a plurality of storage goods carriers (20) on which stored goods (25) may be placed,
at least one access area (6) that is accessible from outside the storage device (1) through an access opening (42) for placing stored goods (25) on a storage goods carrier (20) situated in the access area (6) and/or for removing stored goods (25) from a storage goods carrier (20) situated in the access area (6),
wherein each rack column (4) has storage compartments (18) situated one above the other, in each of which two storage goods carriers (20) are accommodatable one behind the other, viewed from the storage shaft (2),
wherein the storage device (1) includes a conveyor device (10) for transporting at least one storage goods carrier (20) through the storage shaft (2) between one of the storage compartments (18) and the access area (6), and
wherein the storage device (1) has at least one work area (8) that is accessible from outside the storage device (1) and extends below the storage compartments (18) of a rack column (4), from a front side (40) of the storage device (1) toward the storage shaft (2) and up to the access opening (42).

2. The storage device (1) according to claim 1, wherein the work area (8) has a width (50) that corresponds at least to the width (56) of a storage goods carrier (20).

3. The storage device (1) according to claim 1, wherein the sum of the depth (48) of the work area (8) and the depth (60) of the access area (6) corresponds to the depth (62) of one of the rack columns (4).

4. The storage device (1) according to claim 1, wherein a ceiling (46) of the work area (8) is situated higher than a roof (102) of the access area (6).

5. The storage device (1) according to claim 1, wherein the conveyor device (10) is designed
to remove the front storage goods carrier (20) closer to the storage shaft (2) from a storage compartment (18) and move it to the at least one buffer compartment (36);
to remove the rear storage goods carrier (20) farther from the storage shaft (2) from a storage compartment (18) and move it into the access area (6).

6. The storage device (1) according to claim 1, wherein the conveyor device (10) is designed
to remove two storage goods carriers (20) situated one behind the other from a storage compartment (18) and at the same time move them of the at least one buffer compartment (36);
of the two storage goods carriers (20) situated one behind the other, to place the storage goods carrier (20) situated on the side of the access area (6) in the at least one buffer compartment (36); and
to move the remaining storage goods carrier (20) to the access area (6).

7. The storage device (1) according to claim 5, wherein the storage device (1) is designed
to move a storage goods carrier (20) from the access area (6) to the at least one buffer compartment (36); and
to pick up a storage goods carrier (20) that is placed in the at least one buffer compartment (36), to move the picked-up storage goods carrier (20), together with the storage goods carrier (20) that is moved from the access area (6) to the buffer compartment (36), to a free storage compartment (18, 124), and to set down both storage goods carriers (20) there.

8. The storage device (1) according to claim 5, wherein the at least one buffer compartment (36) is situated above the access area (6) and/or above the work area (8).

9. The storage device (1) according to claim 8, wherein the at least one buffer compartment (36) is situated directly above and/or below the access area (6).

10. The storage device (1) according to claim 1, wherein two storage goods carriers (20) situated one behind the other in a storage compartment (18) each have mutually complementary couplings (26), which in the coupled-together state (28) tightly connect the two storage goods carriers (20) to one another.

11. The storage device (1) according to claim 10, wherein the couplings (26) have a coupleable or uncoupleable design due to a vertical relative movement (32) of two storage goods carriers (20) situated directly one behind the other.

12. The storage device (1) according to claim 1, wherein a robot (86) is situated in the work area (8).

13. The storage device (1) according to claim 1, wherein a fastening point (128) that is mounted on the supporting structure of the storage device (1) and/or a plug (130) that is connected to lines for power supply and/or for data exchange are/is situated above the work area (8).

14. The storage device (1) according to claim 1,
wherein at least one apparatus (64) from the following group of apparatuses (64) is situated in the work area (8):
a clothes hook (66),
a sound source (68),
a fragrance dispenser (70),
a light source (72) that is variable with regard to a light spectrum and/or lighting intensity,
at least one drawer (74),
a camera (76),
an air conditioning unit (78),
a device for wireless data transmission (80),
a replaceable floor covering (82) on the floor (84) of the work area (8),
a projector with a projection surface (132),
a screen (134), and
an operator panel (136).

15. The storage device (1) according to claim 1,
wherein the conveyor device (10) has at least two shelf surfaces (34) situated one above the other with respect to a longitudinal axis (11) of the storage shaft (2), wherein at least one storage goods carrier (20) is placeable on each of the shelf surfaces (34).
